(19) United States
(12) Patent Application Publication
(10) Pub. No.: US 2005/0238775 A1
(43) Pub. Date: Oct. 27, 2005

(54) Butter melter and warmer

(76) Inventor: Juan J. Amodei, Dunstable, MA (US)

Correspondence Address: George W. Neuner;Edwards & Angell, LLP, P.O. Box 55874, Boston, MA, 02205, US

(21) Appl. No.: 10/830,610

(22) Filed: Apr. 22, 2004

(51) Int. Cl. A21D 2/00

(52) U.S. Cl. 426/520

(57) ABSTRACT

A device capable of use at a dinner table for warming butter is described. A frame holds a water container and a butter container for heating by a heating element. The butter container is supported at least partially within the water container in spaced relationship thereto, thereby providing a space for water to be heated by the heating element to keep the butter warm without burning. Preferably, the frame has comprises three sections including a bottom support section. an intermediate section and a top section. The intermediate section connects the bottom and top section and provides means for positioning the heating element in relation to the water container, and the top section has a ring for holding the water container.

### FIELD OF THE INVENTION

The invention relates to a device for melting and/or warming melted butter, particularly to a device for warming melted butter without burning the butter for use on a table while dining.

### BACKGROUND OF THE INVENTION

Many dishes (such as boiled lobsters) and cooking applications require over an extended period access to melted butter that is hot enough for use while dining or for the application, yet, not so hot to result in burning the butter or frying food dipped in the butter or to which the butter is applied.

Conventional butter warmers typically include a heating element, such as a candle in a supporting structure, and a container mounted above the heating element. However, such an approach results in uncontrolled heating that requires continued attention to prevent burning of the butter. This often is achieved by blowing out a candle and relighting it when the butter cools or removing the heated container from the heating element for intervals to keep the temperature of the butter from getting too high.

A heater for butter is described in U.S. Pat. No. 4,102,323. The heater includes a tubular cylindrical housing, preferably of sheet metal, flared at the upper end for retention of a cup shaped receptacle whose contents are to be heated. The housing is elevated on and supported by a plurality of strips, the lower ends of which extend downwardly and outwardly and provide legs, and the upper ends of which extend upwardly and outwardly and provide handles. A plurality of openings are provided in the wall of the housing for access of air to the interior. a vertically movable heater support is provided in the interior of the housing having a base portion and an upright arm with a threaded stud extending outwardly through aligned slots in one of the strips and in the housing wall with a nut accessible on the exterior for locking the base portion at the desired adjusted position of elevation. The base portion supports a cup, preferably of metal, for a candle employed for supplying heat. In this device the candle acts directly on the butter container and the height of the base portion must be adjusted to control the temperature of the butter to avoid burning.

U.S. Pat. No. 4,784,112 describes a container for use in precooked foods. The container comprises a disposable container main body for holding the precooked foods made of incombustible material and a disposable heater device made of incombustible material such as incombustible paper or aluminum, packaged integrally together with the container main body and capable of heating the main body. The container main body and the heater device are engaged to each other by fitting protrusions on the main body into lateral grooves in the heater device so that the main body can be supported at a raised position above the heater device. The container main body may include a cylindrical bellows portion that can vary the capacity of the container by expansion and compression.

U.S. Pat. No. 6,290,412 B1 describes a butter melter and applicator having a height in the range between ten and fifteen inches and a width in a range between three and five inches to accommodate the height and width of a corn cob. The container bottom has a container bottom cone securely affixed thereto extending upwardly therefrom functioning to hold a distal end of a corn cob therein. The butter melter and applicator further has a handle attached to the container side. A lid is sealably removably attachable to the container top. The lid has a lid knob rotatably mounted therethrough. A lid fork, removably insertable into an opposite distal end of a corn cob, is securely affixed to the lid knob extending downwardly therefrom functioning to allow the user to place the butter melter and applicator on a side and rotate the corn cob by rotating the lid knob thereby coating the corn cob with butter. The lid further has a lid lip having a lid skirt having a slightly narrower diameter than the diameter of the container top, the lid skirt extends downwardly from the lid lip functioning to improve sealability between the lid and the container. There is no description as to how the device is used to melt butter and apply the butter to the corn cob.

U.S. Des. Pat. No. 384,142 and U.S. Des. Pat. No. 384,143 each illustrate a design for a potpourri simmer vase, and U.S. Des. Patent No. illustrates a design for a butter warmer. Each of these designs apparently has structure for holding a candle or other heating element under a container to be heated. No provision is illustrated for controlling the heat to provide a temperature to avoid burning the contents of the container.

Of course, double boilers for stove top heating containers are known as described, for example, in U.S. Pat. No. 3,659,584. Also, double walled heating containers are known such as described, for example, in U.S. Pat. No. 1,093,648, U.S. Pat. No. 1,347,428 and U.S. Pat. No. 1,505,703.

However, a simple and reliable device for melting butter or other similar spreads for use at the table during dining and controlling the temperature over an extended period of time still is desired.

### SUMMARY OF THE INVENTION

The invention provides a device suitable for melting and warming butter without burning the butter. The device comprises a supporting frame, a water container, a butter container for holding the butter and a heating element. The frame holds the water container in relation to the heating element to transfer heat to it. The butter container is positioned in the water container wherein portions of the water container are in spaced relationship with the butter container to permit water to be located therebetween. Preferably, a plurality of protrusions are located on one of the containers to maintain the spaced relationship therebetween.

In one embodiment, the water container is supported by a ring and is in spaced relationship to the butter container positioned within it.

In another embodiment, the butter container has projections extending below the lower surface of its bottom that contact the water container and hold the two in spaced relationship.

In yet another embodiment, the water container has projections extending above the upper surface its bottom that contact the butter container and hold the two in spaced relationship.

Alternatively, the butter container has a plurality of projections extending substantially radially from a surface thereof that contact the water container and hold the two in spaced relationship. Preferably, one of the projections provides a handle for convenient lifting of the butter container.

The butter container preferably has a weight sufficient to avoid floating in the water contained in the water container. The water container preferably has a water level indicator to indicate the desired level of water to be charged to it.

In a particularly preferred embodiment of the present invention, a butter melting and warming device comprises (a) a frame having a bottom section, an intermediate section connected to the bottom section and a top section connected to the intermediate section thereby being suspended over the bottom and intermediate sections, the top section comprising a ring, (b) a first container capable of holding water and suspended in said ring, and (c) a second container positioned at least partially within the first container, wherein a plurality projections affixed to one of the containers maintains a separation between at least portions of the surface areas of the two containers, and wherein the intermediate section has an opening for positioning a heating element in proximity to the first container for transfer of heat thereto. Preferably, the sections of the frame form a one piece integral frame. For example, the opening can support a tapered candle-like heating element or, alternatively, can position a candle-like heating element that is supported by the bottom section.

As a further alternative, in place of an opening, the intermediate section can provide a support for positioning a heating element in proximity to the first container for transfer of heat thereto. Other alternatives will be apparent to those skilled in the art upon consideration of the detailed description and drawings.

### BRIEF DESCRIPTION OF THE DRAWINGS

FIG. 1 is a perspective view of one embodiment of a butter melting and warming device in accord with the present invention.

FIG. 2 is an exploded perspective view of the butter melting and warming device of FIG. 1, illustrating the butter container component, the water container component an the frame component.

FIG. 3 is a side view of the butter melting and warming device of FIG. 1.

FIG. 4 is plan view of the butter melting and warming device of FIG. 1.

FIG. 5 is a perspective view of an alternative butter container.

FIG. 6 is a plan view of the butter container of FIG. 5.

FIG. 7 is a side view of the butter container of FIG. 5.

FIG. 8 is a side view of the butter container of FIG. 5 nested in a water container.

### DETAILED DESCRIPTION OF THE INVENTION

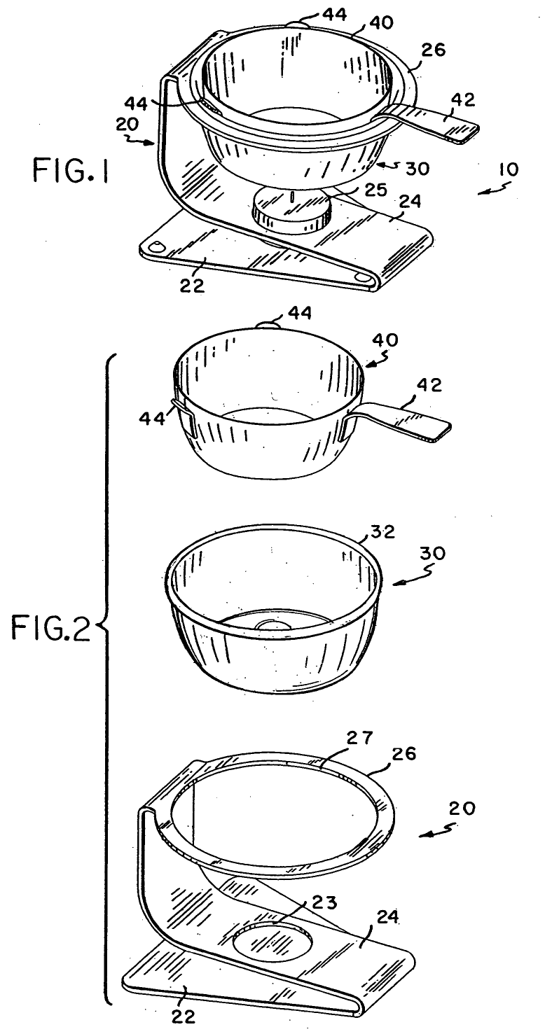

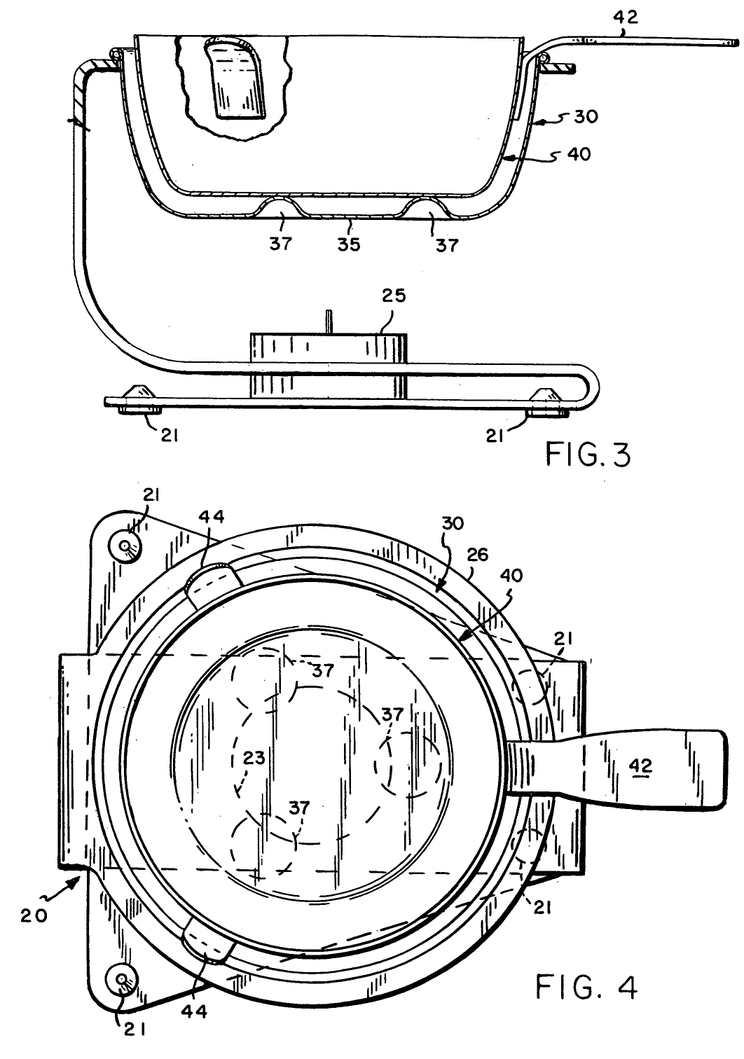

A preferred embodiment of a butter warmer in accord with the present invention is illustrated with reference to FIGS. 1-4. The butter warmer 10 has a frame 20 that can be made of metal or a suitable heat resistant resin. The frame 20 has a bottom section 22, a middle section 24 and a top section 26. The bottom section 22 provides a support surface for the frame. In this embodiment, the bottom section 22 also provides a support surface for a votive candle 25. The middle section 24 connects the bottom section 22 and top section 26. It comprises an opening 23 in which the votive candle 25 is positioned centrally for heating the water container 30. The top section 26 comprises a ring for holding the water container 30. Inside the water container 30 is a butter container 40.

The water container 30 conveniently has a rim 32 for supporting it in the ring opening 27 of the top section 26. The bottom surface 35 of the water container preferably has a plurality of protrusions 37, i.e, bumps, for supporting the butter container and maintaining a space for water. Preferably, a water level line can be placed on the side wall to provide a level indicator for charging water. Conveniently, such water level line is formed in the side wall when making the water container.

The butter container 40 preferably has a plurality of protrusions extending generally radially outward from the container. Preferably, the protrusions comprise a handle 42 and two supporting surfaces 44. The handle 42 and supporting surfaces 44 are conveniently attached to the side wall of the butter container 40. Preferably, the handle and supporting surfaces are spaced about 120° apart, although other spacings are suitable as long as they support the butter container in the water container.

The bottom section 22 of the frame 20 conveniently can be provided with a plurality of feet 21 to lift the bottom section off of a surface on which it is placed.

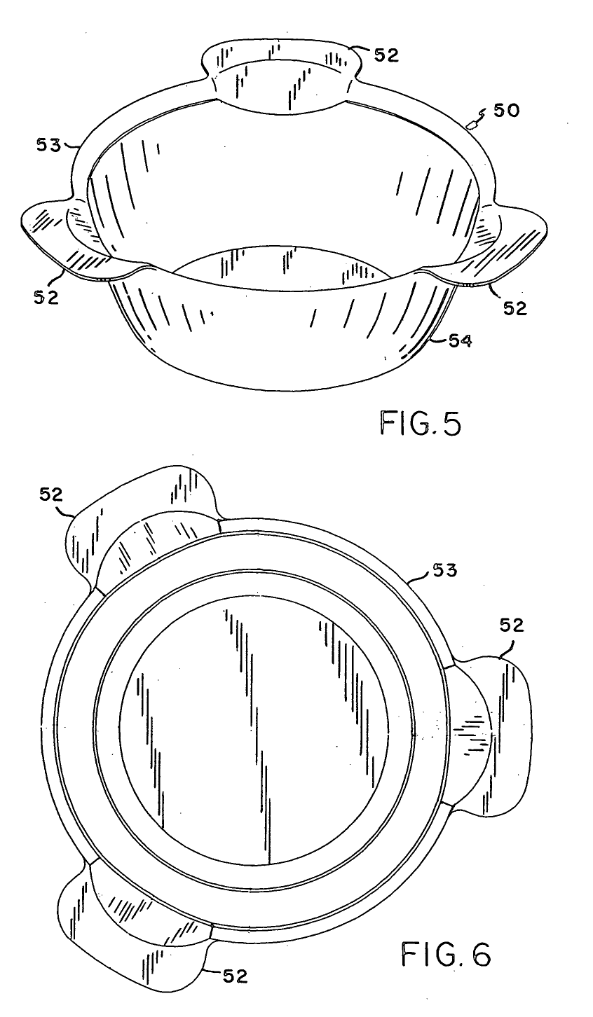

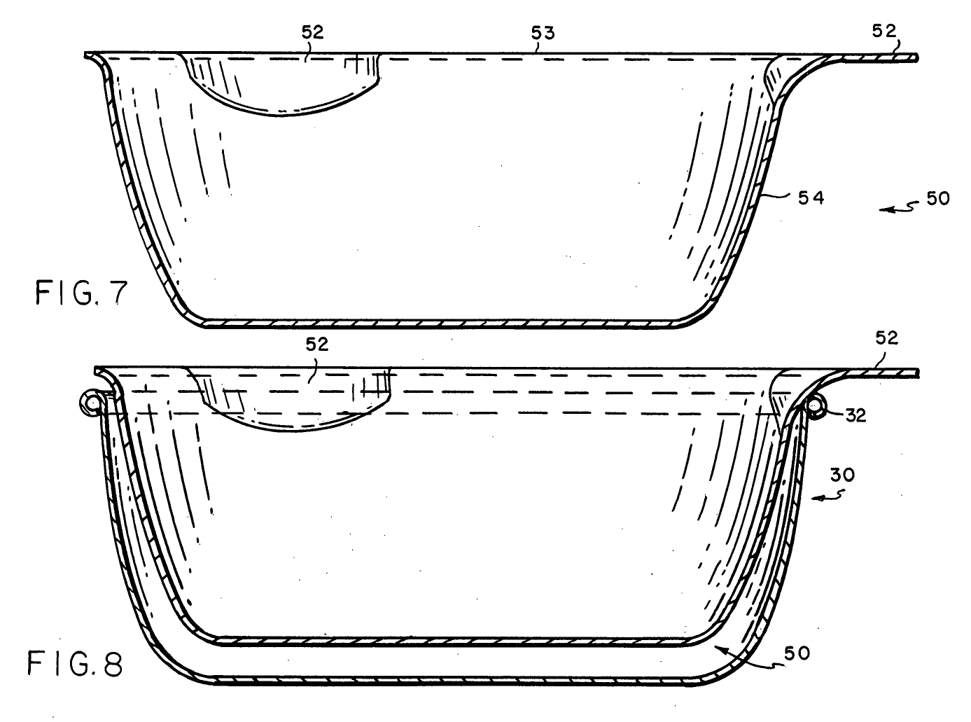

An alternative embodiment of a butter container 50 is illustrated in FIGS. 5-8. In this embodiment, the butter container has three integrally formed support surfaces 52, or ears. The ears extend radially from the top edge 53 of the container side wall 54. The butter container 50 is conveniently supported by its ears 52 on the rim 32 of the water container. As illustrated in FIG. 8, the rim 32 can be formed by rolling the top edge of the side wall of the container 30.

The butter and water containers are preferably made of metal for good heat conduction. Any suitable metal can be used. Typical examples are aluminum, brass, copper, stainless steel, and the like. The butter container can also be formed of heat resistant resin, if desired. The materials are selected typically by balancing the desired aesthetic appearance of the device with ease of manufacture and cost, while providing the necessary heat conduction and heat resistance for the appropriate parts. Also, the material of the inner container should be selected to avoid contamination of any food to be held therein. In addition to melting and warming butter, the device may be used, for example, for a variety of soft spreads that are desired to kept warm. Those skilled in the art can readily choose appropriate materials for the components from well known materials.

The butter warmer is used typically by placing the device on the table during dining. Cool or warm water is placed in the water container. Melted or unmelted butter is placed in the butter container. The heating element is actuated; typically a candle is lighted under the water container. The butter melts and/or is kept warm by the candle without burning due to the mediating effect of the water.

The invention has been described in detail including the preferred embodiments thereof. However, it is recognized that those skilled in the art may make modifications and improvements within the spirit and scope of the invention. For example, an electric resistive heating element can be provided on the frame to provide the heat.

1. A device capable of use at a dinner table for warming butter, said device comprising a frame, a water container and a butter container,
wherein the frame holds the water container and provides a support for a heating element for heating the water container,
wherein the butter container is supported at least partially within the water container in spaced relationship thereto, thereby providing a space for water to be heated by the heating element to keep the butter warm without burning.

2. The device of claim 1, wherein the frame comprises three sections including a bottom support section. an intermediate section and a top section,
wherein the intermediate section connects the bottom and top section and provides means for positioning the heating element in relation to the water container,
wherein the top section comprises a ring for holding the water container.

3. The device of claim 2, wherein the water container comprises a rim to cooperate with the ring for supporting the water container in the frame.

4. The device of claim 3, wherein the rim is a rolled edge of the water container.

5. The device of claim 1, further comprising a plurality of protrusions located on one of the containers to provide the spaced relationship.

6. The device of claim 1, wherein the water container comprises a bottom surface, the bottom surface having a plurality of protrusions for maintaining a space between the water container and the butter container.

7. The device of claim 1, wherein the butter container comprises a plurality of radially extending protrusions to support the butter container in the water container and provide a space between the two containers.

8. The device of claim 7, wherein the protrusions comprise three support surfaces attached to the butter container, at least one of which provides a handle for the butter container.

9. The device of claim 8, wherein the three support surfaces are located on the butter container about 120° apart.

10. The device of claim 8, wherein the three support surfaces comprise three substantially similar ears extending radially from the butter container.

11. The device of claim 1, wherein the water container comprises a water level indicator.

12. A method for holding melted butter at the dining table, said method comprising:
providing a device according to claim 1;
charging the water container with water;
placing melted or unmelted butter into the butter container; and
actuating a heating element to provide heat to the water container, thereby warming the butter in the butter container without burning it.

13. The method of claim 12, wherein the heating element is a candle and actuating the heating element is accomplished by lighting the candle.

14. The method of claim 12, wherein the water container is charged with warm water.
